(19) United States
(12) Patent Application Publication
(10) Pub. No.: US 2004/0239040 A1
(43) Pub. Date: Dec. 2, 2004

(54) Nozzle interstage seal for steam turbines

(76) Inventor: Steven Sebastian Burdgick, Schenectady, NY (US)

Correspondence Address: NIXON & VANDERHYE P.C./G.E., 1100 N. GLEBE RD., SUITE 800, ARLINGTON, VA, 22201, US

(21) Appl. No.: 10/447,112

(22) Filed: May 29, 2003

(51) Int. Cl. F16J 15/447

(52) U.S. Cl. 277/414

(57) ABSTRACT

A seal between the inner ring of a diaphragm nozzle segment and the periphery of a rotor in a steam turbine includes a honeycomb structure brazed onto the radial inner surface of the inner ring segment. The labyrinth teeth on the rotor cut or rub into the surface of the honeycomb structure, forming a seal. The honeycomb structure is preferably a cobalt-based nickel alloy brazed to the inner ring having multi-sided cells opening radially inwardly toward the rotor. The seal precludes or minimizes steam leakage flow between the high pressure upstream flow region and the downstream lower pressure region on opposite sides of the nozzle/rotor interface.

### BACKGROUND OF THE INVENTION

The present invention relates to a seal between a nozzle stage and the rotor of a steam turbine and particularly relates to a honeycomb/labyrinth tooth seal array for sealing between an upstream high pressure region on one side of a nozzle stage/rotor interface and a downstream lower pressure region on an opposite side thereof.

In steam turbine design, it is highly desirable to minimize or eliminate as many steam leakage paths as possible within the turbine secondary leakage flow circuits. As will be appreciated, each stage of a steam turbine includes a rotor mounting a plurality of circumferentially spaced buckets and a diaphragm assembly carrying a plurality of circumferentially spaced partitions. The nozzles, of course, turn the steam flow into the buckets, which in turn extract energy from the flowing steam medium. In reaction-type steam turbines, nozzle segments each carrying one or more partitions are secured in an annular array within an inner casing or shell. A steam leakage path exists between the nozzle and the rotor, particularly between the inner nozzle ring and the periphery of the rotor. This steam leakage bypasses the flow through the nozzles and buckets, i.e., bypasses the intended steam flowpath through the stage and results in reduced stage efficiency and unaccounted steam leakage to the system. Depending upon machining tolerances, runouts, transients, out-of-roundness and nozzle loading, this steam leakage flowpath may be highly variable and is certainly not well controlled. Accordingly, there is a need for an improved seal between the nozzle inner ring and the rotor in a steam turbine.

### BRIEF DESCRIPTION OF THE INVENTION

In accordance with a preferred embodiment of the present invention, there is provided a nozzle interstage seal in a steam turbine which minimizes or precludes steam leakage flow between high and low pressure regions on opposite sides of the nozzle stage in the region between the nozzle inner ring and the rotor. To accomplish the foregoing, a honeycomb structure is provided along the radial inner face of the inner ring of the diaphragm assembly. The honeycomb structure cooperates with one or more labyrinth teeth on the rotor to provide a more efficient seal between the nozzle and the rotor thereby increasing stage efficiency and total machine performance.

Particularly, a metal honeycomb structure is secured, preferably brazed, onto the inner face of the inner ring of the nozzle segments. The honeycomb structure is peripherally bounded by a wall substantially corresponding to the peripheral confines of the inner ring segment portion. The honeycomb structure comprises multi-sided cells which extend in a generally radial inward direction, opening in a direction toward the rotor. One or more labyrinth teeth are provided on the rotor in radial registration with the honeycomb structure. The dimensions and configuration of the honeycomb structure and labyrinth teeth enable the labyrinth teeth to rub into, i.e., cut or machine into, the honeycomb structure to set running clearances. By the cooperation of the labyrinth teeth and the rubbed-in honeycomb structure, increased steam turbulence is provided directly adjacent the seal. By cutting or rubbing in the honeycomb structure by the labyrinth tooth, substantially improved reduction in steam leakage flows are therefore provided.

In a preferred embodiment according to the present invention, there is provided a steam turbine comprising a rotor carrying a plurality of circumferentially spaced buckets, a diaphragm assembly surrounding the rotor and including outer and inner rings carrying a plurality of circumferentially spaced partitions therebetween, the buckets and partitions forming a portion of a steam flowpath through the turbine, a seal between the inner ring of the diaphragm assembly and the rotor including a honeycomb array disposed along a radially inwardly facing surface of the inner ring and an annular labyrinth tooth about a periphery of the rotor, the honeycomb array including a plurality of multi-sided cells projecting from the inner ring and opening toward the rotor, the honeycomb array and the one labyrinth tooth lying in a radial registration with one another with the tooth cutting into the honeycomb array forming the seal between high and low pressure regions on opposite sides of the diaphragm assembly.

In a further preferred embodiment according to the present invention, there is provided a steam turbine comprising a rotor carrying a plurality of circumferentially spaced buckets, a diaphragm assembly surrounding the rotor and including a plurality of diaphragm segments arranged in an annular array thereof with each segment carrying at least one partition between inner and outer ring portions thereof, the buckets and partitions forming a portion of a steam flowpath through the turbine, a seal between the inner ring portions of the diaphragm segments and the rotor including a honeycomb array disposed along radially inwardly facing surfaces of the inner ring portions and an annular labyrinth tooth about a periphery of the rotor, the honeycomb array including a plurality of multi-sided cells projecting from the inner ring portions and opening toward the rotor, the honeycomb array and the one labyrinth tooth lying in a radial registration with one another with the tooth and the honeycomb array forming the seal between high and low pressure regions on opposite sides of the diaphragm assembly.

### BRIEF DESCRIPTION OF THE DRAWINGS

FIG. 1 is a schematic representation of high and intermediate pressure steam turbine sections;

FIG. 2 is an enlarged fragmentary cross-sectional view illustrating a pair of stages for a steam turbine;

FIG. 3 is a schematic fragmentary perspective view of a plurality of diaphragm segments illustrating honeycomb structure portions on the inner ring of each segment;

FIG. 4 is an enlarged view of the honeycomb structure looking radially outwardly and on an enlarged scale for clarity; and

FIGS. 5, 6 and 7 schematically illustrate various embodiments of seals formed between the labyrinth teeth on a rotor and the honeycomb structure on the inner ring of the nozzle.

### DETAILED DESCRIPTION OF THE INVENTION

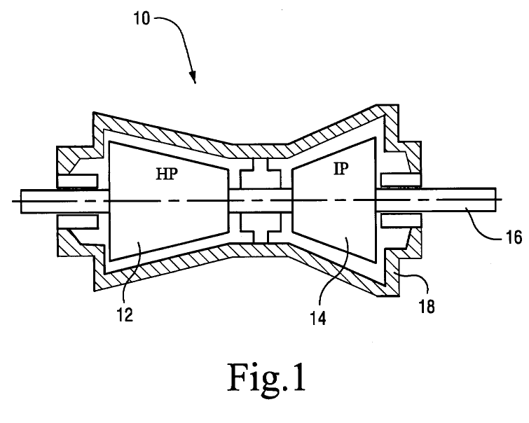

Referring now to the drawings, particularly to FIG. 1, there is illustrated a steam turbine, generally designated 10. Steam turbine 10 in this schematic example is comprised of a high pressure turbine section 12 and an intermediate pressure turbine section 14 mounted on a single integral rotor 16 extending beyond opposite ends of the steam turbine casing 18. It will be appreciated that the rotor 16 is driven in rotation by the high and intermediate pressure sections 12 and 14, while casing 18 remains stationary. It will also be appreciated that the seals of the present invention are also applicable to low pressure turbine sections, although the latter are not illustrated.

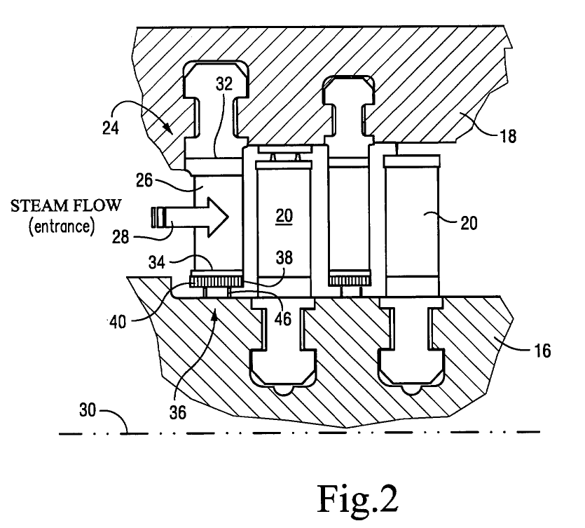

As typical in steam turbines and referring to FIG. 2, rotor 16 mounts a plurality of circumferentially spaced buckets 20 typically having labyrinth-type seals at their tips for sealing with portions of the stationary casing shell 18. Each turbine section also includes a diaphragm assembly, generally designated 24, mounting a plurality of circumferentially spaced partitions 26 defining nozzles therebetween. The axially adjacent partitions 26 and buckets 20 form a stage of the steam turbine 10 and it will be appreciated that two stages are illustrated in FIG. 2, although additional stages are typical. The steam flowpath through the nozzles 26 and buckets 20 is indicated by the steam flow direction arrow 28. The axis of rotation of the rotor is also illustrated at 30.

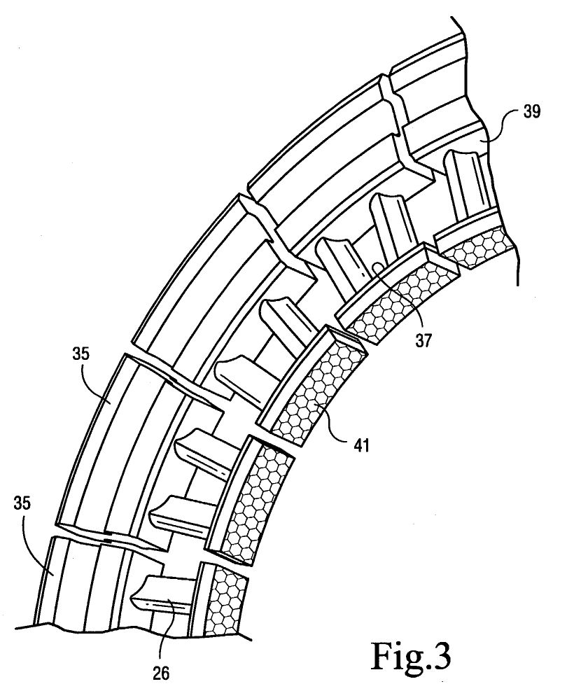

As illustrated in FIG. 2, each of the diaphragm assemblies includes an outer ring 32 and an inner ring 34, between which are mounted the plurality of circumferentially spaced partitions 26. The diaphragm assembly in a typical reaction-type turbine is comprised of a plurality of diaphragm segments 35 (FIG. 3) disposed in a circumferential abutting array thereof, with each segment comprising inner and outer ring portions 37 and 39, respectively, and one or more partitions 26 extending between the inner and outer ring portions. As can be seen from FIG. 2, there is a potential for a steam leakage path between the inner ring 34 of the diaphragm assembly and the outer periphery of the rotor 16. This potential leakage path would extract steam from the intended steam flowpath 28, bypassing the nozzle stage without turning the steam to perform useful work in the follow-on buckets. A unique seal, generally designated 36, is provided in the region between the inner ring of the diaphragm assembly and the registering portions of the periphery of the rotor which seals between the higher pressure region on the upstream side of the diaphragm assembly and the lower pressure region on the downstream side of the diaphragm assembly.

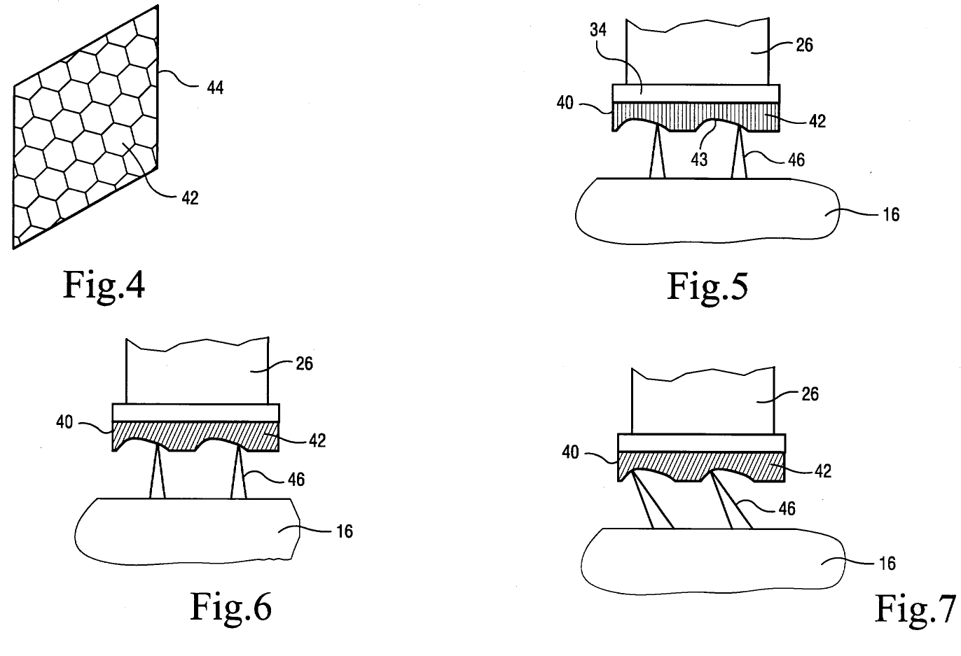

Particularly, an annular array 38 of a honeycomb structure 40 is provided along the radially inner facing surface of the inner ring 34, i.e., forms honeycomb structure portions 41 (FIG. 3) along the radial inner face of the inner ring portion 37 at each diaphragm segment 35. The honeycomb structure is preferably formed of metal, e.g., a cobalt-based nickel alloy, which is secured, preferably brazed, to the inner face of the inner ring 34. As illustrated in FIGS. 2 and 4, the honeycomb structure 40 includes a plurality of multi-sided cells 42. In the illustrated form, the cells are hexagonal, although it will be appreciated that the cells may have any number of sides, e.g., four or more linear sides as desired. Also, the cells 42 open generally in a radial inward direction toward the rotor. A peripheral wall 44 (FIG. 4) is provided about the honeycomb structure and corresponds generally to the peripheral confines of the inner ring segment portion for that particular diaphragm segment 35. The seal also includes one or more labyrinth seal teeth 46 (FIGS. 2 and 5) on rotor 16 which lie in radial registration with the honeycomb structure 40. The seal teeth 46 and honeycomb structure 40 are dimensioned and configured such that the tips of the labyrinth seal teeth 46 cut or rub into the honeycomb structure 40. As illustrated in FIG. 5, the cutting or rubbing in forms grooves 43 in the radial inner surface of the honeycomb structure 40. With the cells of the honeycomb structure opening generally radially inwardly in conjunction with the labyrinth teeth 46, turbulence is created adjacent the seal therebetween, effectively precluding or minimizing steam leakage flow between the nozzle and the rotor between the high pressure upstream region and the lower pressure downstream region on opposite sides of the nozzle/rotor interface.

The honeycomb structure is preferably formed of a thin metal, for example, a cobalt-based nickel alloy, having dimensions ranging from 0.005-0.015 inches thick. A representative cell size is about 1/16th to 3/16th inch wide with a ⅛th inch cell being preferred. The peripheral wall portion 44 surrounding the honeycomb structure 40 confines the projecting edges of the honeycomb structure 40 removed to correspond its periphery to the periphery of the inner ring of the diaphragm segment.

Referring now to FIG. 6, the honeycomb cells 42 of honeycomb structure 40 are angled in an upstream direction, i.e., toward the high pressure region on the upstream side of the nozzle. In FIG. 7, both the honeycomb cells and the labyrinth teeth are angled in the same direction, i.e., toward the high pressure upstream side of the nozzle. In both cases, an increased pressure drop occurs when the honeycomb cells or combined honeycomb cells/teeth are angled into the flow toward the high pressure side, hence forming an effective seal.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A high or intermediate pressure steam turbine comprising:
a rotor carrying a plurality of circumferentially spaced buckets;
a diaphragm assembly surrounding the rotor and including outer and inner rings carrying a plurality of circumferentially spaced partitions therebetween, the buckets and partitions forming a portion of a steam flowpath through a stage of the high or intermediate pressure steam turbine;
a seal between the inner ring of the diaphragm assembly and the rotor including a honeycomb array disposed along a radially inwardly facing surface of said inner ring and an annular labyrinth tooth about a periphery of the rotor;
said honeycomb array including a plurality of multi-sided cells projecting from the inner ring and opening toward the rotor, said honeycomb array and said one labyrinth tooth lying in a radial registration with one another with the tooth cutting into the honeycomb array forming said seal between high and low pressure regions on opposite sides of the diaphragm assembly.

2. A steam turbine according to claim 1 wherein said tooth forms a radially outwardly extending groove in the radially inner face of the honeycomb array.

3. A steam turbine according to claim 1 wherein each of the cells of the honeycomb array have at least four linear sides.

4. (CANCELED)

5. (CANCELED)

6. A steam turbine according to claim 1 wherein said honeycomb array is formed of metal.

7. A steam turbine according to claim 1 wherein said honeycomb array is formed of a cobalt-based nickel alloy.

8. A steam turbine according to claim 1 wherein the cells of the honeycomb array are inclined forwardly toward the high pressure region of the steam turbine.

9. A steam turbine according to claim 1 wherein the labyrinth tooth is inclined forwardly toward the high pressure region.

10. A steam turbine according to claim 8 wherein the labyrinth tooth is inclined forwardly toward the high pressure region.

11. A steam turbine according to claim 1 including a second annular labyrinth tooth about the periphery of the rotor spaced axially from the first-mentioned tooth, the second tooth lying in radial registration with said honeycomb array and cutting into the honeycomb array forming a portion of the seal between the high and low pressure regions on opposite sides of the diaphragm assembly.

12. A high or intermediate pressure steam turbine comprising:
a rotor carrying a plurality of circumferentially spaced buckets;
a diaphragm assembly surrounding the rotor and including a plurality of diaphragm segments arranged in an annular array thereof with each segment carrying at least one partition between inner and outer ring portions thereof, the buckets and partitions forming a portion of a steam flowpath through a stage of the high or intermediate pressure steam turbine;
a seal between the inner ring portions of the diaphragm segments and the rotor including a honeycomb array disposed along radially inwardly facing surfaces of said inner ring portions and an annular labyrinth tooth about a periphery of the rotor;
said honeycomb array including a plurality of multi-sided cells projecting from the inner ring portions and opening toward the rotor, said honeycomb array and said one labyrinth tooth lying in a radial registration with one another with the tooth and the honeycomb array forming said seal between high and low pressure regions on opposite sides of the diaphragm assembly.

13. A steam turbine according to claim 12 wherein each of the cells of the honeycomb array have at least four linear sides.

14. A steam turbine according to claim 12 wherein said honeycomb array comprises a plurality of honeycomb segments having peripheral confines corresponding generally to the peripheral confines of the inner band portion.

15. A steam turbine according to claim 14 wherein each honeycomb segment is bounded by a linear extending peripheral wall.

16. A steam turbine according to claim 12 wherein said honeycomb array is formed of metal.

17. A steam turbine according to claim 12 wherein said honeycomb array is formed of a cobalt-based nickel alloy.

18. A steam turbine according to claim 12 wherein the cells of the honeycomb array are inclined forwardly toward the high pressure region of the steam turbine.

19. A steam turbine according to claim 12 wherein the labyrinth tooth is inclined forwardly toward the high pressure region.

20. A steam turbine according to claim 18 wherein the labyrinth tooth is inclined forwardly toward the high pressure region.
